(19) United States
(12) Patent Application Publication
(10) Pub. No.: US 2011/0136092 A1
(43) Pub. Date: Jun. 9, 2011

(54) EDUCATIONAL SYSTEMS, METHODS AND APPARATUS

(75) Inventor: William Murray, Ormond (AU)

(73) Assignee: FULL CIRCLE EDUCATION PTY LTD, Melbourne, VI (AU)

(21) Appl. No.: 13/056,763

(22) PCT Filed: Jul. 30, 2008
(86) PCT No.: PCT/AU2008/001103

§ 371 Date: Jan. 31, 2011

(51) Int. Cl. G09B 7/00

(52) U.S. Cl. 434/322

(57) ABSTRACT

Systems, methods and apparatus for organising and monitoring education of one or more students are disclosed. The apparatus comprises a topic planner for the student comprising at least one topic category to be studied by the student and a student tracker linked to the topic planner for tracking progress by the student in studying the at least one topic category. Embodiments include a master sheet linked to the topic planner for each student, the master sheet identifying each student, a subject and one or more subject topics, and a class tracker linked to one or more of the topic planner, the master sheet and/or the student tracker for tracking progress by each student in studying each topic and each topic category.

### FIELD OF THE INVENTION

Embodiments of the present invention relate generally to educational systems, methods and apparatus. In particular, embodiments of the present invention relate to educational systems, methods and apparatus for planning lessons, monitoring student progress and providing feedback.

### BACKGROUND TO THE INVENTION

Education is the foundation for producing intelligent, well rounded and productive members of society. The quality of the education is dependent on the ability of the educator to provide effective education, which can be affected by many factors, such as the amount of contact time between the educator and the students, the abilities of the individual students, the range of abilities in each class or group of students, the nature and quantity of the subject matter, the time available to learn the subject matter, the methods of assessment of the students and the nature of the feedback to the students and their parents or guardians.

Lesson planners are a common way in which the subject matter to be learned is divided up over a period of time, such as a term, and broken down into individual lessons identifying the topics comprising the subject. Both conventional and electronic lesson planners are available to aid in the formulation of lessons and whilst some are unnecessarily complex or difficult to implement, many are to some extent successful in organising the work to be learned. However, one drawback of most lesson planners is that they are formulated for a class of students with a range of abilities and are therefore aimed at the average students. Consequently, the less able students find it difficult to keep up whilst the more able students are insufficiently challenged and quickly become disinterested. There are increasing pressures on educators to differentiate learning in mixed ability groups of students and educators are increasingly being assessed on this.

Assessment is another important aspect of education and typical formats include assignments, essays, projects, examinations and the like. Whilst a grade or a report provides an indication of the student's attainment, this is typically at the end of a period of study when it is too late to implement the feedback provided.

Other problems associated with current education methods and tools include the amount of educators' time consumed by administration, which reduces the teaching time available, the lack of student engagement in programs of study, the pressures on both students and educators to complete programs of study in specific time frames and diminished motivation.

In this specification, the terms “comprises”, “comprising”, “includes”, “including” or similar terms are intended to mean a non-exclusive inclusion, such that a method, system or apparatus that comprises a list of elements does not include those elements solely, but may well include other elements not listed.

### OBJECT OF THE INVENTION

It is an object of the present invention to provide an educational system and/or an educational method and/or an educational apparatus that addresses or at least ameliorates one or more of the aforementioned problems or provides consumers with a useful commercial alternative.

### SUMMARY OF THE INVENTION

According to one aspect, although not necessarily the broadest or only aspect, embodiments of the present invention reside in an apparatus for organising and monitoring education of a student, the apparatus comprising:

a topic planner for the student comprising at least one topic category to be studied by the student; and

a student tracker linked to the topic planner for tracking progress by the student in studying the at least one topic category.

Preferably, the topic planner comprises a plurality of topic categories corresponding to one or more levels in an educational scheme. Examples of such topic categories include, but are not limited to, core material, classroom tasks, consolidation material, enrichment tasks, extension material.

Preferably, the at least one topic category in the topic planner is selected according to the respective student's ability.

Preferably, the student tracker comprises one or more indicia to indicate whether or not the respective student has completed each topic category.

Preferably, the student tracker comprises an indicium to indicate whether or not the respective student has completed a task for each topic category.

Preferably, the student tracker is linked to the topic planner such that updating the topic planner to indicate completion of a topic category automatically updates the student tracker.

Preferably, the apparatus comprises a master sheet linked to the topic planner for each student, the master sheet identifying each student, a subject and one or more subject topics.

Preferably, the apparatus comprises a class tracker linked to one or more of the topic planner, the master sheet and/or the student tracker for tracking progress by each student in studying each topic and each topic category.

Preferably, the class tracker comprises an indicium to indicate whether or not each student has completed each task comprising each topic category for each topic.

Preferably, the apparatus is implemented in a computer.

According to another aspect, although again not necessarily the broadest aspect, embodiments of the present invention reside in a method of organising and monitoring education of a student, the method including:

generating a topic planner for the student, the topic planner comprising at least one topic category to be studied by the student; and

linking a student tracker to the topic planner for tracking progress by the student in studying the at least one topic category.

Preferably, the method includes providing the topic planner with a plurality of topic categories corresponding to one or more levels in an educational scheme.

Preferably, the method includes selecting the at least one topic category in the topic planner according to the respective student's ability.

Preferably, the method includes indicating in the student tracker with one or more indicia whether or not the respective student has completed each topic category.

Preferably, the method includes indicating in the student tracker with an indicium whether or not the respective student has completed a task comprising each topic category.

Preferably, the method includes linking the student tracker to the topic planner such that updating the topic planner to indicate completion of a topic category automatically updates the student tracker.

Preferably, the method includes linking a master sheet to the topic planner for each student, the master sheet identifying each student, a subject and one or more subject topics.

Preferably, the method includes linking a class tracker to one or more of the topic planner, the master sheet and/or the student tracker for tracking progress by each student in studying each topic and each topic category.

Preferably, the method includes indicating in the class tracker with an indicium whether or not each student has completed a task comprising each topic category for each topic.

According to a further aspect, although again not necessarily the broadest aspect, embodiments of the present invention reside in an apparatus for organising and monitoring education of a student, the apparatus comprising:

computer readable program code components configured to cause generating a topic planner for the student, the topic planner comprising at least one topic category to be studied by the student; and

computer readable program code components configured to cause linking a student tracker to the topic planner for tracking progress by the student in studying the at least one topic category.

Preferably, the apparatus comprises computer readable program code components configured to cause providing the topic planner with a plurality of topic categories corresponding to one or more levels in an educational scheme.

Preferably, the apparatus comprises computer readable program code components configured to cause selecting the at least one topic category in the topic planner according to the respective student's ability.

Preferably, the apparatus comprises computer readable program code components configured to cause indicating in the student tracker with one or more indicia whether or not the respective student has completed each topic category.

Preferably, the apparatus comprises computer readable program code components configured to cause indicating in the student tracker with an indicium whether or not the respective student has completed a task comprising each topic category.

Preferably, the apparatus comprises computer readable program code components configured to cause linking the student tracker to the topic planner such that updating the topic planner to indicate completion of a topic category automatically updates the student tracker.

Preferably, the apparatus comprises computer readable program code components configured to cause linking a master sheet to the topic planner for each student, the master sheet identifying each student, a subject and one or more subject topics.

Preferably, the apparatus comprises computer readable program code components configured to cause linking a class tracker to one or more of the topic planner, the master sheet and/or the student tracker for tracking progress by each student in studying each topic and each topic category.

Preferably, the apparatus comprises computer readable program code components configured to cause indicating in the class tracker with an indicium whether or not each student has completed a task in each topic category for each topic.

According to another aspect, although again not necessarily the broadest aspect, embodiments of the present invention reside in a computer readable medium comprising the aforementioned computer readable program code components for organising and monitoring education of a student.

According to a yet further aspect, although again not necessarily the broadest aspect, embodiments of the present invention reside in a system for educating a student comprising:

a processor coupled to be in communication with a storage device via a communications network, the storage device comprising a topic planner for the student comprising at least one topic category to be studied by the student and a student tracker linked to the topic planner for tracking progress by the student in studying the at least one topic category.

Further features and aspects of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is an apparatus for organising and monitoring education of one or more students according to embodiments of the present invention;

FIG. 2 is a system for organising and monitoring education of one or more students according to embodiments of the present invention;

FIG. 3 is a schematic representation of elements of the apparatus of FIG. 1;

FIG. 4 is a schematic representation of three topic planners of the apparatus of FIG. 3;

FIG. 5 shows further detail of part of one of the topic planners shown in FIG. 4;

FIG. 6 shows further detail of a student tracker of the apparatus of FIG. 3;

FIG. 7 shows further detail of a master sheet of the apparatus of FIG. 3;

FIG. 8 shows further detail of a class tracker of the apparatus of FIG. 3;

FIG. 9 shows multiple class tracker tables of the class tracker;

FIG. 10 shows part of another example of a class tracker;

FIG. 11 shows a further example of a class tracker; and

FIG. 12 is a general flow diagram illustrating a method of organising and monitoring education of one or more students according to embodiments of the present invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

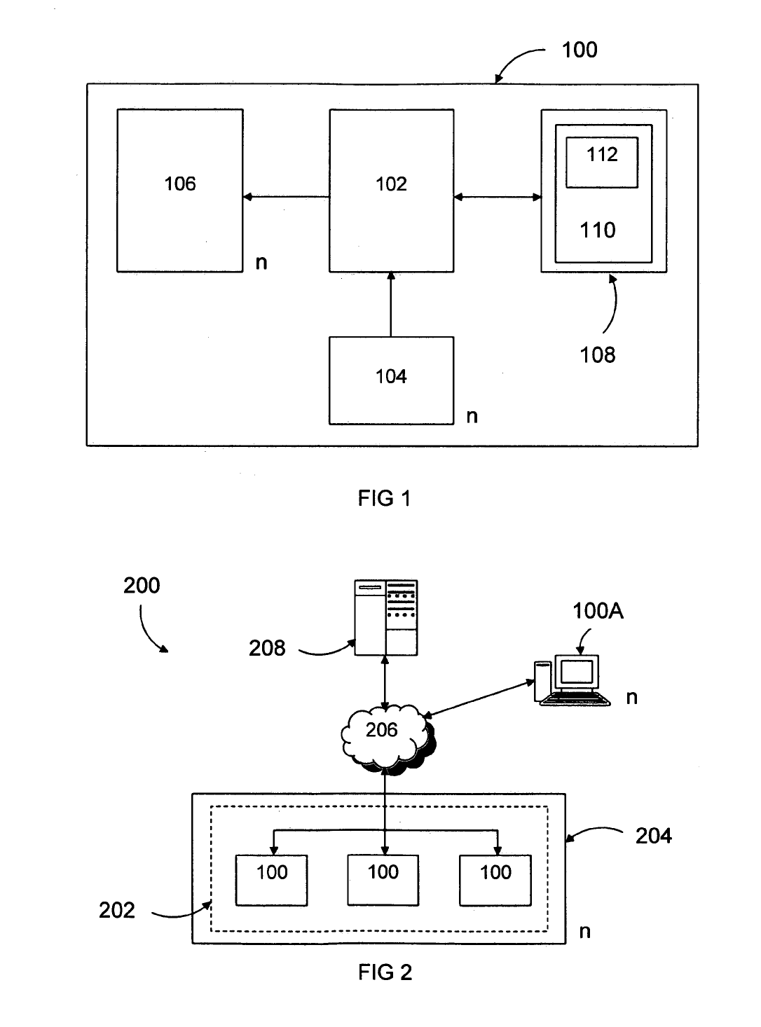

With reference to FIG. 1, an apparatus 100 for organising and monitoring the education of one or more students is provided in accordance with embodiments of the present invention. Apparatus 100 comprises a processor 102 operatively coupled to one or more input devices 104, such as a keyboard, mouse and/or other suitable input device. Processor 102 is operatively coupled to one or more output devices 106, such as a screen, printer and/or other suitable output device. According to some embodiments, the output device 106 can be in the form of a touch screen, which can therefore also act as an input device. Processor 102 is also operatively coupled to a storage medium in the form of memory 108.

Memory 108 comprises a computer readable medium 110, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as is well known in the art. The computer readable medium 110 comprises computer readable program code components 112 for organising and monitoring education of one or more students in accordance with the teachings of the present invention, at least some of which are selectively executed by the processor 102 and are configured to cause the execution of the embodiments of the present invention described herein.

Examples of apparatus 100 include, but are not limited to, personal, laptop or notebook computers, personal digital assistants (PDAs), portable multimedia devices, mobile telephones and other computing devices.

Referring to FIG. 2, a system 200 for organising and monitoring education of one or more students is provided in accordance with embodiments of the present invention. System 200 comprises one or more apparatus 100 as described above coupled to be in communication via a communication network 202, such as a local area network (LAN) for an educational institution 204, such as a school, college, university or the like. The communication network 202 is coupled to be in communication with a global communication network 206, such as the Internet. Apparatus 100 are coupled to be in communication with a storage device 208, such as a server or other computing device, via global communications network 206 and communication network 202 as appropriate. One or more apparatus 100A can be coupled to be in communication with storage device 208 and/or communication network 202 of an educational institution 204 via global communications network 206 as appropriate. For example, apparatus 100A can be in use by a distance learning student in communication with the educational institution 204 and/or the storage device 208. It will be appreciated that system 200 can comprise one or more apparatus 100A and one or more educational institutions 204 each comprising one or more communication networks 202. The aforementioned communications can be effected by a combination of wired and/or wireless connections as is well known in the art.

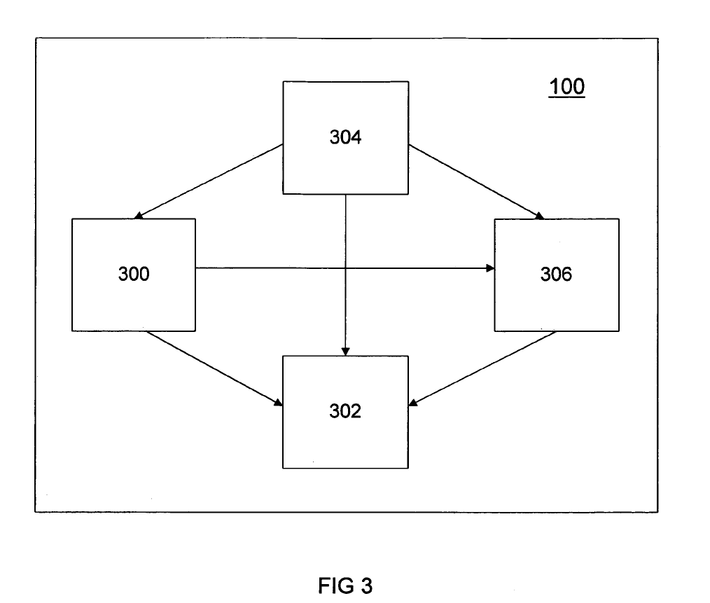

With reference to FIG. 3, a computer implemented apparatus 100 for educating one or more students is provided in accordance with embodiments of the present invention. Apparatus 100 comprises a topic planner 300 for each student comprising at least one topic category to be studied by the student. Apparatus 100 also comprises a student tracker 302 linked to the topic planner 300 for tracking progress by the student in studying the at least one topic category. A student tracker 302 is provided for each student and is linked to a respective topic planner 300 for the student. According to some embodiments, apparatus 100 also comprises a master sheet 304 linked to the topic planner 300 for each student. The master sheet 304 identifies each student, a subject and one or more subject topics. According to some embodiments, apparatus 100 also comprises a class tracker 306 linked to one or more of the topic planner 300, the master sheet 304 and/or the student tracker 302 for tracking progress by each student in studying each topic and each topic category.

In preferred embodiments, the master sheet 304 is linked to the class tracker 306, which is linked to each student tracker 302. A topic planner 300 for each student is linked to the master sheet 304 and to each respective student tracker 302.

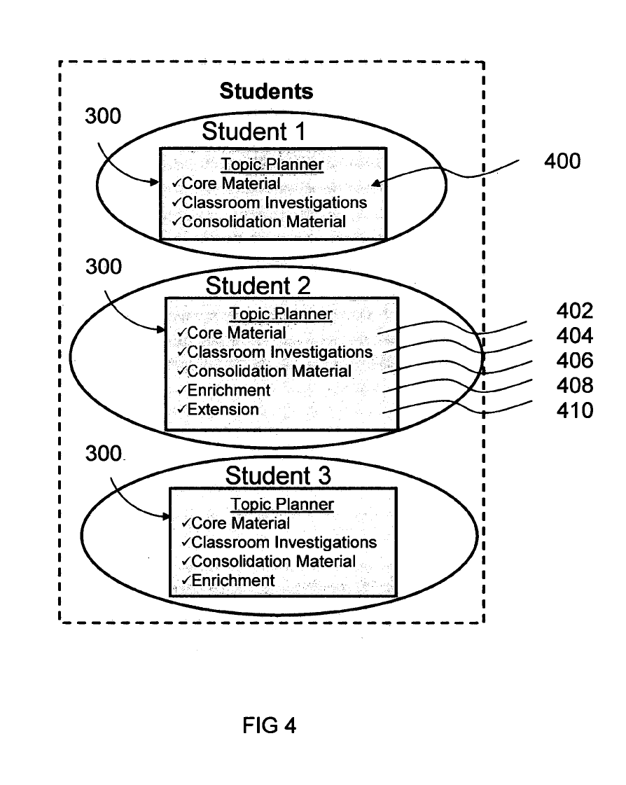

With reference to FIG. 4, the topic planner 300 for each student comprises a plurality of topic categories 400 corresponding to one or more educational levels in an educational scheme. Examples of such topic categories 400 include, but are not limited to, core material 402, classroom activities/tasks/investigations 404, consolidation material 406, enrichment tasks 408 and extension material 410. Such topic categories are used in, for example, the Victorian Essential Learning Standards (VELS) in Australia, but it will be appreciated other topic categories can be used according to the learning standards employed in a particular jurisdiction. In other embodiments, one or more of the topic categories 400 can be merged together to form a single category. In the VELS educational scheme, completion of the various topic categories 400 leads to a Personal Learning (PL) grade and a VELS grade as shown in Table 1 below.

With reference to Table 1, under the VELS educational scheme, it is necessary for a student to complete the core material and the classroom tasks for the student to attain a PL grade C and a VELS grade C. If the student completes further tasks in the other topic categories 400, the student can attain the corresponding PL and VELS grades shown in Table 1.

TABLE 1
TOPIC CATEGORIES LINKED TO:
PERSONAL LEARNING (PL) AND VELS STATUS

| | PL | VELS |
|---|---|---|
| CORE MATERIAL | — | — |
| CLASSROOM TASKS | C | C |
| CONSOLIDATION | B | C |
| ENRICHMENT | A | B |
| EXTENSION | A | A |

It can be seen in FIG. 4 that the topic categories 400 in the topic planner 300 for each student are selected according to the respective student's ability. For example, the topic planner 300 for Student 1 comprises three topic categories 400 whereas the topic planner 300 for Student 2 comprises five topic categories 400 and the topic planner 300 for Student 3 comprises four topic categories 400. Student 2 is considered the most able of the three students represented and therefore the topic planner 300 comprises the most topic categories 400 to challenge the student, maintain their interest, provide goals for the student to achieve and maximise the student's potential. The student can therefore plan their time accordingly to cover the planned topics. A less able student is likely to require more time to complete topics, but because they have a topic planner 300 tailored to their abilities, the student can plan their time accordingly to complete the tasks required to attain at least an average grade and the student is not left behind or frustrated because they are unable to keep up with a topic planner directed to the class as a whole. The topic planner 300 enables each student to monitor their own learning and provides each student with individual responsibility and accountability for their own progress.

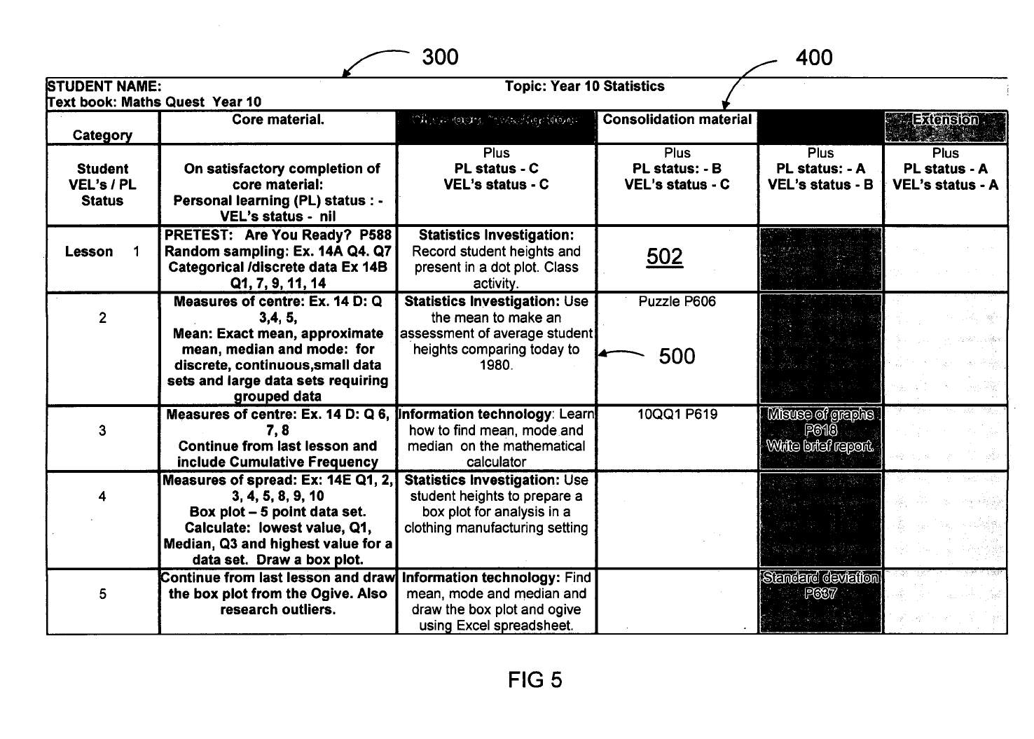

FIG. 5 shows part of one of the topic planners 300 for a student in further detail. The topic planner 300 in FIG. 5 is for the subject mathematics and the topic of year 10 statistics. The topic planner 300 identifies the student, the text book or other source material being used for the topic and comprises each topic category 400. The topic planner 300 comprises a series of lessons and lessons 1-5 are shown in FIG. 5. The topic planner 300 comprises a series of blocks, segments or fields 500, each of which summarises the tasks or activities to be completed in each lesson for each topic category 400. For this student, lesson 1 comprises tasks for the topic categories 400 of core material 402 and classroom tasks/investigations 404, but no tasks or activities are specified for consolidation material 406, enrichment tasks 408 or extension material 410 as indicated by the blank segments 502. However, for this student, lesson 3, for example, comprises tasks of consolidation material and enrichment tasks further illustrating how each topic planner 300 is tailored to each student's needs and abilities.

According to some embodiments, the blocks, segments or fields 500 of the topic planner 300 can be colour coded or shaded according to the lesson and/or the topic category and the colour coding or shading can be changed when the task or activity has been completed by the student. The blocks, segments or fields 500 of the topic planner 300 can be linked to the class tracker 306 and the student tracker 302 such that when the topic planner 300 is updated, the corresponding fields in the class tracker 306 and the student tracker 302 are automatically updated.

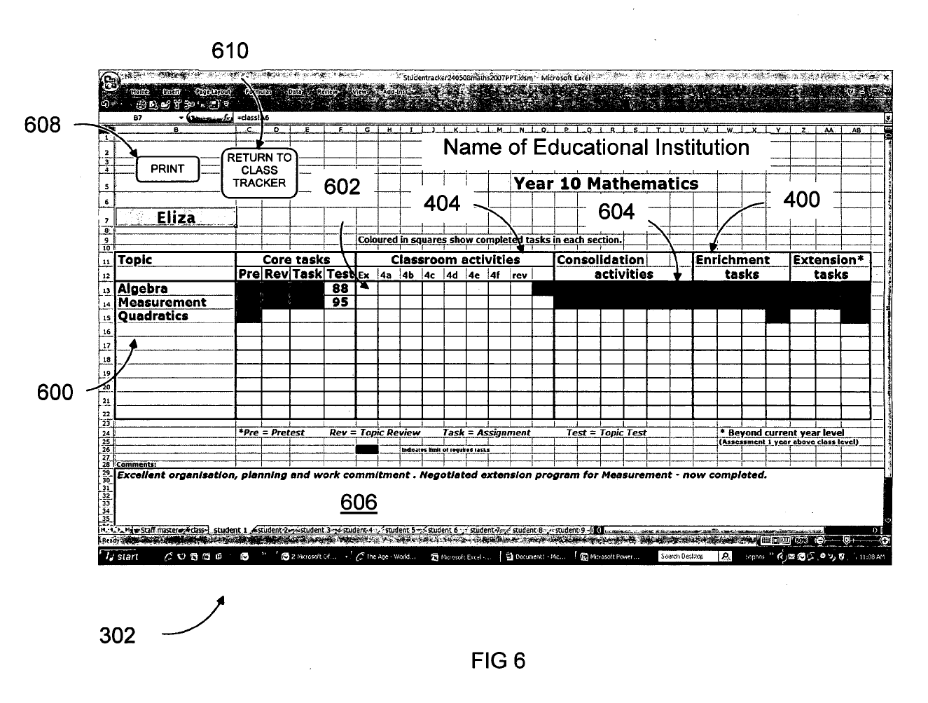

FIG. 6 shows the student tracker 302 for a student in further detail. The student tracker 302 is linked to the topic planner 300 for the respective student for tracking progress by the student in studying the topic categories 400 for each subject. The student tracker 302 identifies the educational institution, the subject, which in this example is Year 10 mathematics, and the student. The student tracker 302 lists vertically the topics 600 for the subject and the lists horizontally the topic categories 400 for the subject. It will be appreciated that in alternative embodiments the topics 600 can be listed horizontally and the topic categories 400 can be listed vertically.

The student tracker 302 comprises one or more indicia 602 to indicate whether or not the respective student has completed each topic category. In the embodiment shown in FIG. 6, the student tracker 302 comprises a plurality of indicia 602, an indicium 602 to indicate whether or not the respective student has completed each task or activity in each topic category 400 for each topic in the subject. For example, as shown in FIG. 6, the student tracker 302 comprises an indicium 602 to indicate whether or not the respective student has completed the tasks or activities labelled Ex. (example), 4a, 4b, 4c, 4d, 4e, 4f and rev. (review/revision) for the topic category of classroom activities/tasks 404 for the mathematics topics algebra, measurement and quadratics. In this embodiment, each indicium 602 is in the form of a box or field that is shaded and/or coloured to indicate the completion of a task or activity or is left blank to indicate that the task or activity has not been completed by the respective student. In FIG. 6, all of the indicia 602 for all the topic categories 400 for the topics algebra and measurement are coloured indicating that all of the tasks for these topics in each topic category 400 have been completed by the student. Only three of the tasks in the topic category of classroom activities/tasks 404 for the quadratics topic have been completed.

FIG. 6 also shows that the student tracker 302 comprises a test score for each topic that has been completed to date by the student and an indicium 604 indicating the limit of the required tasks for each topic category 400. The student tracker 302 also comprises a comments field 606 in which an educator can enter comments in relation to the respective student's performance, behaviour, effort and the like. The student tracker 302 is therefore very useful in providing feedback not only to the student, but also to the parent(s) or guardian(s) of the student. Indeed, the student tracker 302 informs the educator, student and parent(s)/guardian(s) of the progress of the student in each subject and in each topic for each subject for each topic category 400. This enables timely feedback to be provided to all interested parties regarding the student's progress. The topic planner 300 can be modified in view of the feedback if required.

The student tracker 302 also comprises a print icon 608 to send the information in the student tracker to an output device 106 in the form of a printer. The student tracker 302 also comprises an icon 610 to return to the class tracker 306, which will be described in more detail hereinafter.

In alternative embodiments, the indicia 602 can take other forms, such as symbols to indicate whether or not the respective student has completed a task. For example, a tick, a number one or a smiley face can be used to indicate completion of a task and a cross, a zero or a frowning face can be used respectively to indicate that a task has not been completed by a student. In some embodiments, entering a number one on a particular field followed by pressing the enter/return key causes the filed to be coloured or shaded.

According to some embodiments, the student tracker 302 is linked to the topic planner 300 such that updating the topic planner 300 to indicate completion of a topic category 400, or a task or activity in a topic category 400, automatically updates the indicia 602 in the student tracker 302. For example, where embodiments of the present invention are implemented in a spreadsheet application, fields representing the indicia 602 in the student tracker 302 can be linked to the fields 500 representing the tasks in the topic planner 300.

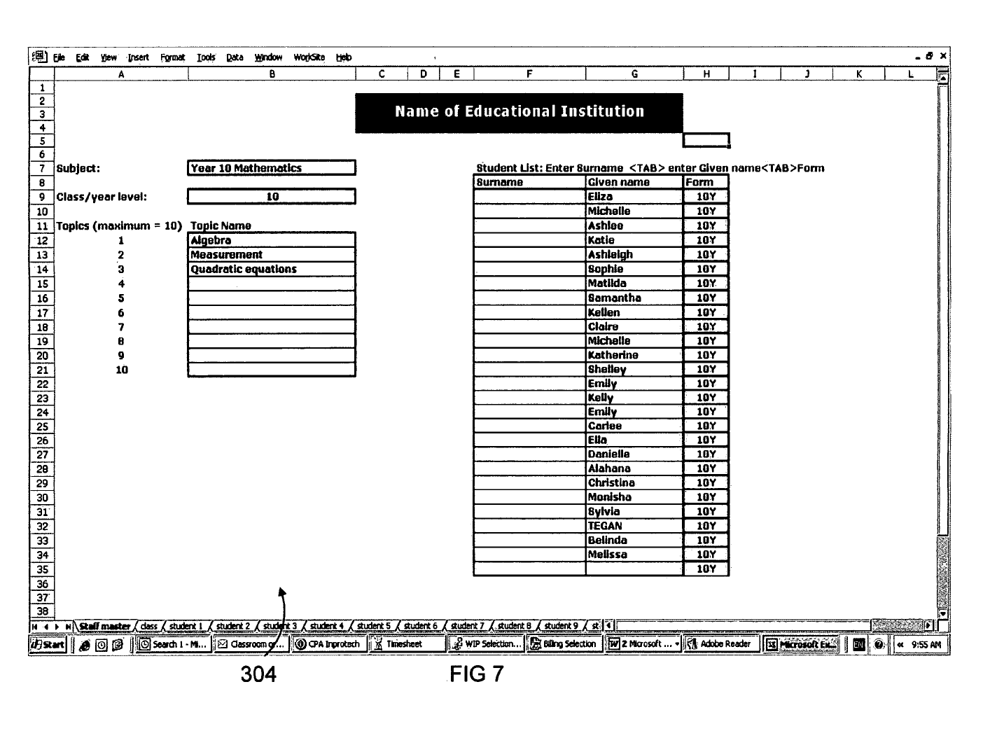

Reference is now made to FIG. 7 in which the master sheet 304 is shown in more detail. The master sheet 304 identifies an educational institution, a year level and class, each student, a subject and one or more topics for the subject. In this embodiment a maximum of ten topics can be entered for a subject, but in other embodiments other limits or no limits apply. The master sheet 304 is linked to the topic planner 300 for each student.

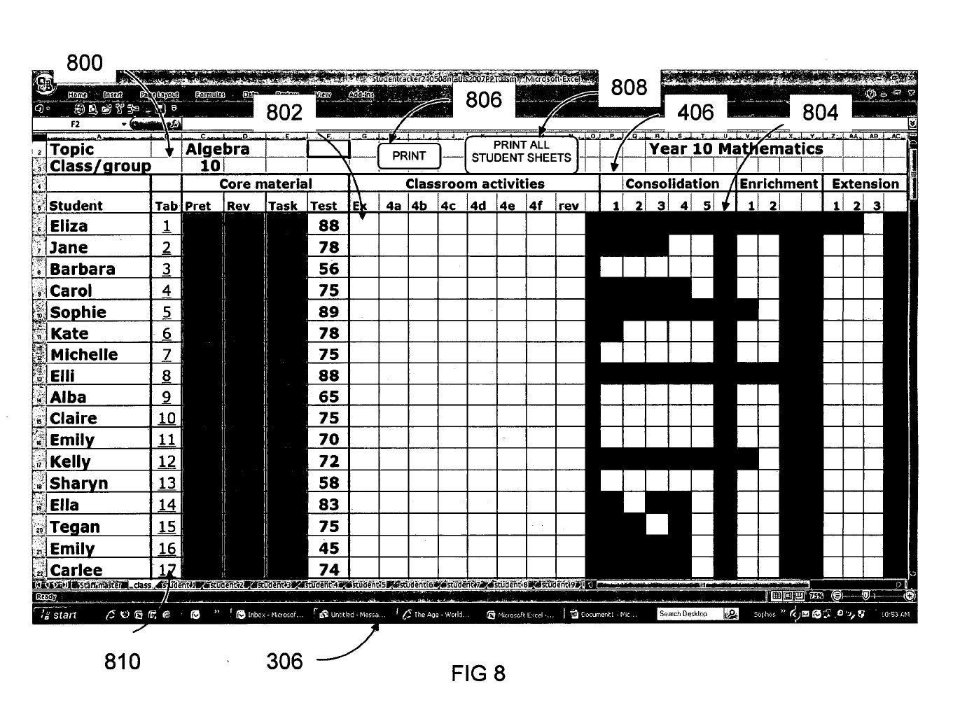

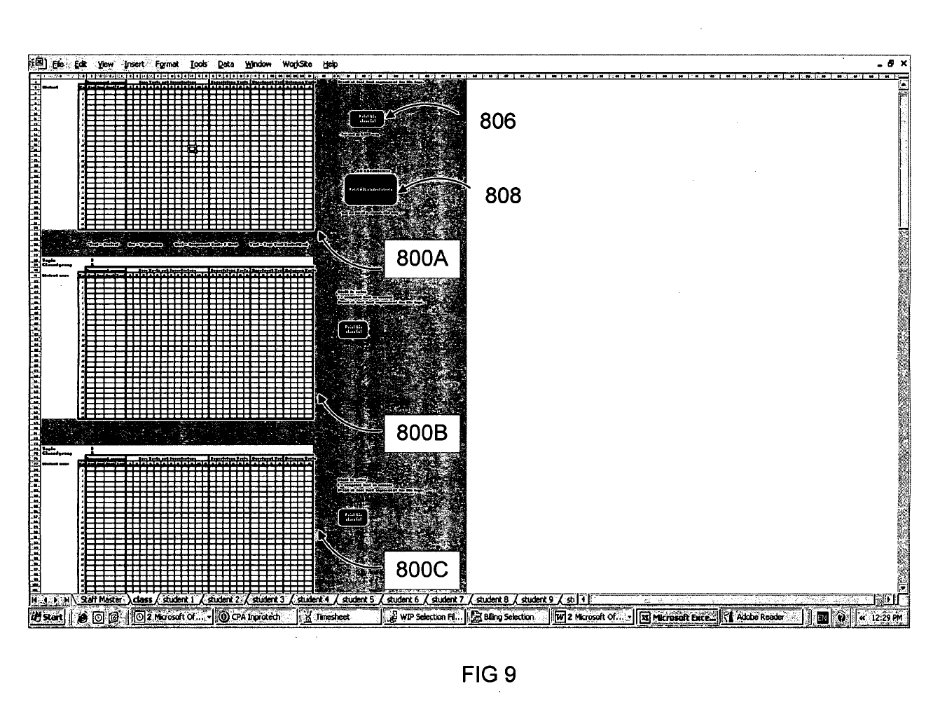

Reference is now made to FIG. 8 in which the class tracker 306 is shown in more detail. The class tracker 306 is linked to one or more of the topic planner 300, the master sheet 304 and/or the student tracker 302 for tracking progress by each student in studying each topic and each topic category. The class tracker 306 comprises a plurality of class tracker tables 800, one for each topic and one of which is shown in FIG. 8. The class tracker table 800 specifies a year, a subject, a topic and a class or group identifier and tracks each student in the class or group. In the example shown in FIG. 8, the class tracker table 800 is for a year 10 mathematics class and the topic is algebra.

The class tracker table 800 comprises a plurality of indicia 802 to indicate whether or not each student has completed each topic category 400 for each topic. An indicium 802 indicates whether or not each student has completed a particular task or activity for each topic category 400 for each topic. For example, for the first student named Eliza, indicia 802 indicate that the student has completed tasks 1-5 of the consolidation topics 406 for algebra and an indicium 804 indicates that the limit of the required tasks for the consolidation topics 406 has been reached by the student.

The student tracker 302 for the student named Eliza shown in FIG. 6 reflects the class tracker table 800 for the same student shown in FIG. 8. In the student tracker 302, indicia 602, 604 show the same level of progress for the student for the mathematics topic algebra as shown in the class tracker table 800 in FIG. 8. The student tracker 302 for this student also shows the student's progress in the other mathematics topics being studied by the student.

The class tracker 306 also comprises a print icon 806 to send the information in the class tracker table 800 currently on display in the class tracker to an output device 106 in the form of a printer. The class tracker 306 also comprises an icon 808 to print all tables 800 for all topics and subjects on a class by class basis as described in further detail hereinafter. Each class tracker table 800 comprises an icon 810 next to each student's name which links the class tracker table 800 of the class tracker 306 to the student tracker 302 for the respective student. Hence, the educator can easily and efficiently monitor the student's progress compared with their peers and the student's progress across a range of topics for each subject.

With reference to FIG. 9, the class tracker 306 can track a whole class or group of students for each subject and topic the students in each class are studying. The class tracker 306 comprises a class tracker table 800 for each topic the class or group of students are studying. For example, for the subject of year 10 mathematics, class tracker table 800A can be for algebra, class tracker table 800B can be for trigonometry, class tracker table 800C can be for quadratics and so on. Hence, the educator can easily and efficiently monitor the progress of each student and the class as a whole for each topic in each subject.

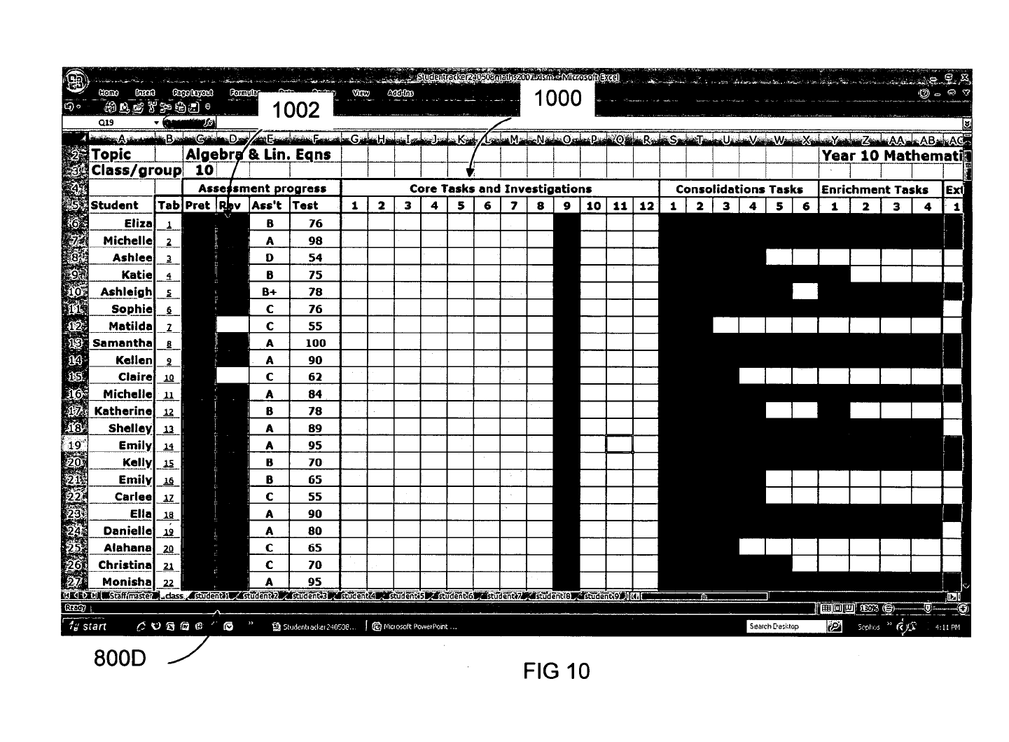

FIG. 10 shows part of another example of the class tracker 306. FIG. 10 shows a class tracker table 800D for the year 10 mathematics topic of algebra and linear equations. In this example the topic categories of core material 402 and classroom activities/tasks/investigations 404 have been merged into a single topic category 1000 entitled core tasks and investigations. Class tracker table 800D also shows the assessment progress of each student by virtue of indicia 1002 showing whether or not each student has completed pre-test and revision assessment tasks. Assessment progress is also shown with assessment grades and text scores.

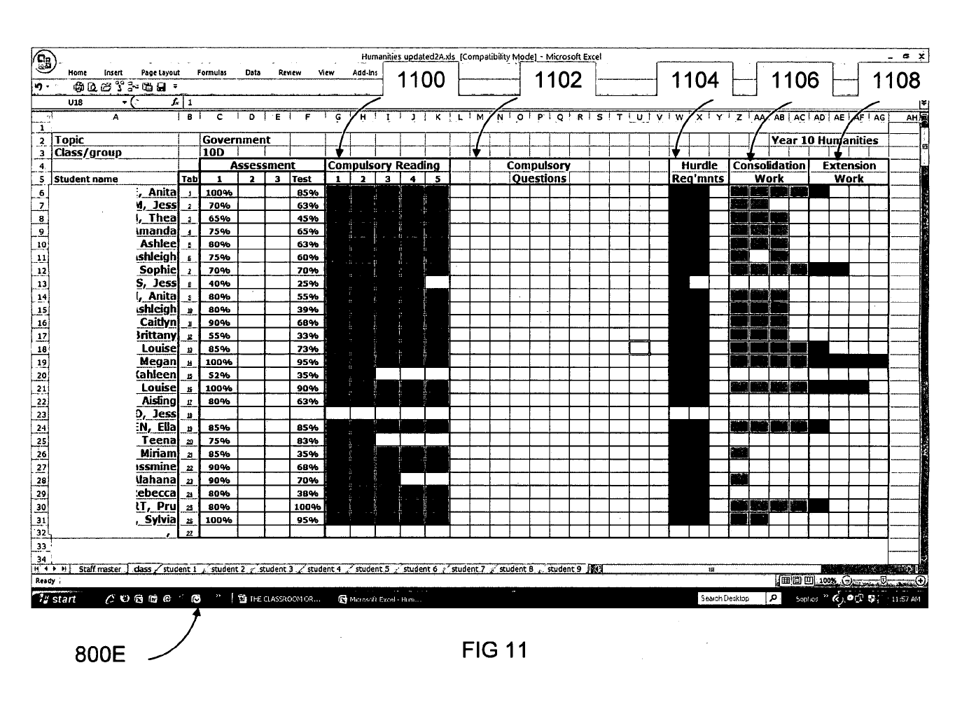

Referring to FIG. 11, another example of the class tracker 306 is shown. FIG. 11 shows a class tracker table 800E for the humanities topic of government. In this example, the topic categories 400 are in the form of compulsory reading 1100, compulsory questions 1102, hurdle requirements 1104, consolidation work 1106 and extension work 1108. As with previous examples, indicia indicate whether or not each student has completed a particular task or activity for each topic category 400 for the topic.

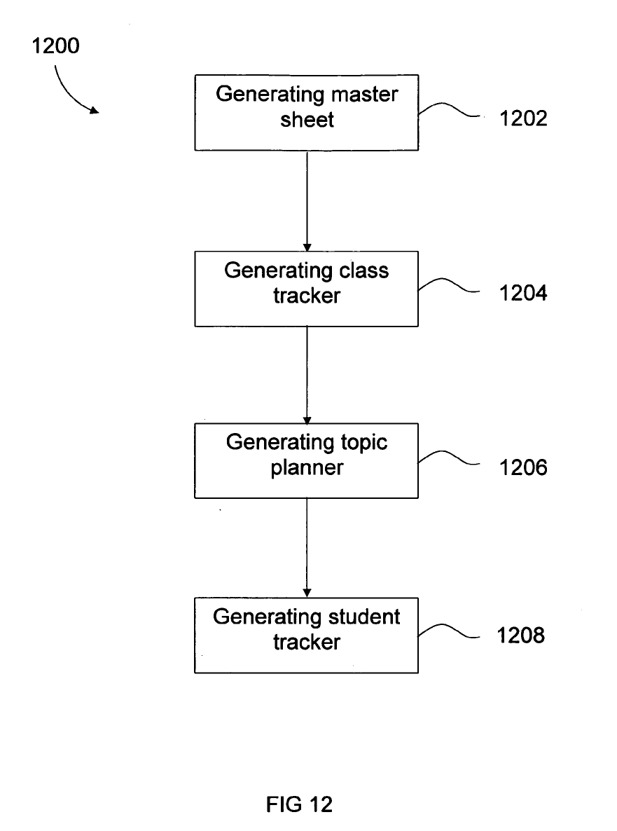

Methods 1200 of organising and monitoring the education of one or more students in accordance with embodiments of the present invention will now be described with reference to the general flow diagram in FIG. 12.

According to some embodiments, the method 1200 includes at 1202 generating the master sheet 304, which includes entering the names of students, the subject and topics being studied and other information, such as the year, class and form name or number.

According to some embodiments, the method 1200 includes at 1204 generating the class tracker 306 and linking the class tracker 306 to the master sheet 304. The class tracker 306 is automatically populated by the data entered into the master sheet 304.

The method 1200 includes at 1206 generating the topic planner 300 for each student. As described above, the topic planner 300 comprises at least one topic category 400 to be studied by the student.

The method includes at 1208 linking the student tracker 302 to the topic planner 300 for tracking progress by the student in studying the at least one topic category. As data is updated in the class tracker 306, the student tracker 302 is updated automatically.

According to some embodiments, the method includes linking the class tracker 306 to one or more of the topic planner 300 and/or the student tracker 302 for tracking progress by each student in studying each topic and each topic category 400. The method can also include linking the master sheet 304 to the topic planner 300 for each student such that changes in the master sheet 304 are reflected in the topic planner 300.

The method includes providing the topic planner 300 with a plurality of topic categories 400 corresponding to one or more levels in an educational scheme, such as the VELS scheme. The method includes selecting the one or more topic categories 400 in the topic planner 300 according to the respective student's ability. The method further includes indicating in the student tracker 302 with one or more indicia whether or not the respective student has completed a task for each topic category.

The method can include indicating in the class tracker table 800 of the class tracker 306 with one or more indicia whether or not each student has completed a task for each topic category 400. The method can include indicating in the class tracker table 800 of the class tracker 306 with an indicium a limit of the tasks required for completion of each topic category 400. The method can include linking the class tracker table 800 of the class tracker with an icon 810 for each student to the student tracker for the respective student.

In accordance with embodiments of the present invention, the system 200 is therefore provided for organising and monitoring education of one or more students. The system 200 comprises the processor 102 coupled to be in communication with the storage device 208 via communications network 206. According to some embodiments, the storage device 208 comprises the topic planner 300 for the student comprising at least one topic category 400 to be studied by the student and a student tracker 302 linked to the topic planner 300 for tracking progress by the student in studying the at least one topic category 400.

It will be appreciated that the systems, methods and apparatus according to embodiments of the present invention can be used to organise and monitor the education of one or more students for a wide range of subjects, whether to conventional classes of students in classrooms or the like or to distance learning students dispersed anywhere around the globe via the communication networks.

It is envisaged that links can be provided, for example, in the student tracker 302, to generate reports for the students in electronic and/or printed format. Most, if not all, of the information required to provide an accurate and useful report for each student is captured by the embodiments of the present invention, thus further reducing the administrative burden on educators. Reports can be emailed to parent(s)/guardian(s) via the communications network 206. It is also envisaged that parent(s)/guardian(s) can be provided access to one or more elements of the system, method and apparatus of the present invention with the appropriate security measures. For example, parent(s)/guardian(s) can be provided access to the student tracker 300 for their child to enable them to see at a glance their child's progress. Alternatively, the student tracker 300 can be emailed to the student and/or the parent(s)/guardian(s) periodically to keep them up to date of the student's progress.

Class rolls or registers can also linked to one or more of the topic planner 300, the student tracker 302, the class tracker 306 and/or the master sheet 304. Indeed, the master sheet 304 would only require minor modification to act as a class register. In some embodiments, topic start and end dates and/or more extensive student assessment files can be included. It is also envisaged that the system and apparatus can be linked to, or integrated with, other educational tools and learning resources such that completion of a topic or task in another linked application automatically updates the topic planner 300, the student tracker 302 and/or the class tracker 306.

Whilst embodiments of the present invention have been described in the context of being implemented in a computer, it will be appreciated that according to some embodiments of the present invention, one or more elements can be implemented in a printed format. For example, the topic planner 300 for each student can be updated manually by the student or educator when the student completes a specific task or activity. The class tracker 304 and consequently the student tracker 302 can subsequently be updated according to the tasks completed by the student as shown on the amended topic planner 300.

Hence, embodiments of the present invention address or at least ameliorate the aforementioned problems of the prior art. The systems, methods and apparatus for organising and monitoring the education of one or more students as described herein provide each student with a topic planner 300 tailored to their abilities. Each topic planner 300 is linked to the class tracker 306 to enable the educator to see at a glance the progress of each student in a class for each subject, topic, topic category and task or activity for each topic category. The linked student tracker 302 provides a detailed breakdown of the progress of a particular student and the student's progress in the context of the student's ability.

The systems, methods and apparatus for organising and monitoring the education of one or more students as described herein utilise a detailed teacher activity plan and record student performance in a way that encourages student engagement, self paced learning and strong student-teacher communication. It also supplies the teacher with an efficient way of tracking student progress in a more effective way. This leads to a reduced administrative work load for the teacher and allows more time to facilitate student needs and report more effectively in a time efficient manner. The systems, methods and apparatus provide planning and tracking tools using a minimum of documentation and demonstrate the educators' abilities to differentiate learning in mixed ability groups. The systems, methods and apparatus provide a well defined, systematic way to implement lesson plans across a range of student abilities that are easy for the educators, students and parent(s)/guardian(s) to follow without creating extra administrative work for the educator.

Throughout the specification the aim has been to describe the invention without limiting the invention to any one embodiment or specific collection of features. Persons skilled in the relevant art may realize variations from the specific embodiments that will nonetheless fall within the scope of the invention. For example, the topic planner 300, the student tracker 302, the class tracker 306 and/or the master sheet 304 can be customized by the educator according to different parameters or variables, such as the number of students, the subjects and topic categories 400 being taught, and the educational scheme being utilised.

1.-2. (canceled)

3. The apparatus of claim 27, wherein the topic categories comprise one or more of the following: core material, compulsory reading, compulsory questions, classroom tasks, consolidation material, hurdle requirements, enrichment tasks, extension material.

4.-14. (canceled)

15. A method of organising and monitoring education of a plurality of students including:
generating a topic planner for each student, the topic planner comprising at least one topic category of one or more topics for a subject to be studied by the respective student;
linking a student tracker to the topic planner for tracking progress by the respective student in studying the at least one topic category and providing feedback for each respective student relating to the at least one topic category as the at least one topic category is being studied; and
linking a master sheet to each topic planner and each student tracker, the master sheet identifying each student, the subject and the one or more topics.

16. The method of claim 15, including providing the topic planner with a plurality of topic categories corresponding to one or more levels in an educational scheme.

17. The method of claim 15, including selecting the at least one topic category in the topic planner according to the respective student's ability.

18. The method of claim 15, including indicating in the student tracker with one or more indicia whether or not the respective student has completed each topic category.

19. The method of claim 15, including indicating in the student tracker with an indicium whether or not the respective student has completed a task for each topic category.

20. The method of claim 15, including linking the student tracker to the topic planner such that updating the topic planner to indicate completion of a topic category automatically updates the student tracker.

21. The method of claim 15, wherein the student tracker comprises a comments field in which an educator can provide feedback relating to the respective student's performance, behaviour, effort or the like.

22. The method of claim 15, including linking a class tracker to one or more of the topic planner, the master sheet and/or the student tracker for tracking progress by each student in studying each topic and each topic category.

23. The method of claim 22, including indicating in a class tracker table of the class tracker with one or more indicia whether or not each student has completed each topic category for each topic.

24. The method of claim 22, including indicating in a class tracker table of the class tracker with an indicium whether or not each student has completed a task for each topic category.

25. The method of claim 22, including indicating in a class tracker table of the class tracker with an indicium a limit of the tasks required for completion of each topic category.

26. The method of claim 22, including linking a class tracker table of the class tracker with an icon for each student to the student tracker for the respective student.

27. An apparatus for organising and monitoring education of a plurality of students, the apparatus comprising:
computer readable program code components configured to cause generating a topic planner for each student, the topic planner comprising at least one topic category of one or more topics for a subject to be studied by the respective student;
computer readable program code components configured to cause linking a student tracker to the topic planner for tracking progress by the respective student in studying the at least one topic category and providing feedback for each respective student relating to the at least one topic category as the at least one topic category is being studied; and
computer readable program components configured to cause linking a master sheet to each topic planner and each student tracker, the master sheet identifying each student, the subject and the one or more topics.

28. The apparatus of claim 27 comprising computer readable program code components configured to cause providing the topic planner with a plurality of topic categories corresponding to one or more levels in an educational scheme.

29. The apparatus of claim 27 comprising computer readable program code components configured to cause selecting the at least one topic category in the topic planner according to the respective student's ability.

30. The apparatus of claim 27 comprising computer readable program code components configured to cause indicating in the student tracker with one or more indicia whether or not the respective student has completed each topic category.

31. The apparatus of claim 27 comprising computer readable program code components configured to cause indicating in the student tracker with an indicium whether or not the respective student has completed a task for each topic category.

32. The apparatus of claim 27 comprising computer readable program code components configured to cause linking the student tracker to the topic planner such that updating the topic planner to indicate completion of a topic category automatically updates the student tracker.

33. The apparatus of claim 27 comprising computer readable program code components configured to cause providing the student tracker with a comments field in which an educator can provide feedback relating to the respective student's performance, behaviour, effort or the like.

34. The apparatus of claim 27 comprising computer readable program code components configured to cause linking a class tracker to one or more of the topic planner, the master sheet and/or the student tracker for tracking progress by each student in studying each topic and each topic category.

35. The apparatus of claim 34 comprising computer readable program code components configured to cause indicating in a class tracker table of the class tracker with one or more indicia whether or not each student has completed each topic category for each topic.

36. The apparatus of claim 34 comprising computer readable program code components configured to cause indicating in a class tracker table of the class tracker with an indicium whether or not each student has completed a task for each topic category.

37. The apparatus of claim 34 comprising computer readable program code components configured to cause indicating in a class tracker table of the class tracker with an indicium a limit of the tasks required for completion of each topic category.

38. The apparatus of claim 34 comprising computer readable program code components configured to cause linking a class tracker table of the class tracker with an icon for each student to the student tracker for the respective student.

39. A computer readable medium comprising computer readable program code components for organising and monitoring education of a plurality of students, the computer readable program code components configured to cause:
generating a topic planner for each student, the topic planner comprising at least one topic category of one or more topics for a subject to be studied by the respective student;
linking a student tracker to the topic planner for tracking progress by the respective student in studying the at least one topic category and providing feedback for each respective student relating to the at least one topic category as the at least one topic category is being studied; and
linking a master sheet to each topic planner and each student tracker, the master sheet identifying each student, the subject and the one or more topic.

40. A system for organising and monitoring education of a plurality of students comprising a processor coupled to be in communication with a storage device via communications network, the storage device comprising a topic planner for each student comprising at least one topic category of one or more topics for a subject to be studied by the respective student, a student tracker linked to the topic planner for tracking progress by the respective student in studying the at least one topic category and providing feedback for each respective student relating to the at least one topic category as the at least one topic category is being studied, and a master sheet linked to each topic planner and each student tracker, the master sheet identifying each student, the subject and the one or more topic.
